(19) United States
(12) Patent Application Publication
(10) Pub. No.: US 2008/0276171 A1
(43) Pub. Date: Nov. 6, 2008

(54) Filing System

(76) Inventor: Itzchak Sabo, Halamish (IL)

Correspondence Address: Sean Liam Kelleher;Kelleher IP, PLLC, 16 Peckslip Rd, Carmel, NY, 10512, US

(21) Appl. No.: 11/562,983

(22) Filed: Nov. 23, 2006

Related U.S. Application Data
(60) Provisional application No. 60/740,283, filed on Nov. 29, 2005.

(51) Int. Cl. G06F 3/048

(52) U.S. Cl. 715/711; 715/853

(57) ABSTRACT

A filing assistant for coupling to an e-mail application; the email application comprising a message database for storing and retrieving messages and a graphical user interface (GUI) for displaying the messages and for allowing the user to otherwise interact with the application, the filing assistant comprising a display and indexer for generating an optimized folder index.

### BACKGROUND OF THE INVENTION

1. Field of the Invention

The present invention is directed to providing an intuitive and user-friendly interface for filing data in a computerized environment.

2. Summary of the Prior Art

Before the information age, documentation of importance was catalogued or indexed and then archived. If the information was correctly archived it could be found and accessed at a later date. Otherwise it was simply “lost in the filing system”, and to all intents and purposes, could have been filed in the waste-paper basket.

No filing system is perfect. By way of analogy, the Dewey Decimal System categorizes books and other publications into classes representing different subject matter. Each publication is filed (shelved) together with other publications having similar subject matter. To find a book by a particular author, without knowing the subject matter is daunting.

In contradistinction, alphabetical filing of publications by name of author is great if the author's name is known, but finding a different book on a similar topic by a different author becomes difficult.

Both the above systems tend to waste space as deep, widely spaced shelves are required to accommodate the larger books, unless these are separately filed with other outsized books. On the other hand, filing books by size or binding type looks nice and is appropriate for display shelves in a private dwelling or similar usage, where relatively few books are displayed as ornaments, rather than used for reference purposes. To show the development of a subject, even literature, it might be useful to file books in chronological order. Typically, a mixed filing system is used, with categories such as medieval literature, 19^{th} century literature, twentieth century novels and the like, being arranged alphabetically, or by size or binding type.

Data within a computer system is arranged in files which may be tagged with links and those links are typically arranged in folders. It will be appreciated that where and how the data is actually stored within a memory is of little interest to the user, who is ambivalent as to whether the data is stored magnetically or optically, whether accumulated in one place or another, or scattered over a hard disk. To access the data, what is important is that the links or tags are easily scanned or searched.

Most systems for ordering computerized data are modeled on real world filing systems, and arrange the data into folders, (otherwise known as directories), which may, in turn, be arranged into a hierarchical structure of folders and subfolders. If the system is good, it enables data files to be easily and intuitively found by a user. Ideally, both the filing system and the locating of filed computerized data should be intuitive.

By way of example, electronic mail, or email, as it is generally called, is a preferred means of communication. It is relatively informal, but has the advantage (and disadvantage) that messages may be kept in their entirety for future reference. Though widely used informally, increasingly, emails are used for business communication and may establish contracts and other legal obligations. For these and other reasons, it is desirable, and may be imperative to keep copies of both sent and received emails.

Merely having copies saved, is almost valueless if such copies are inaccessible, and, in a wealth of scenarios, it is desirable, if not essential, to file emails in some searchable and retrievable manner.

Current standard email programs, such as Microsoft Office Outlook™, Outlook Express™, Thunderbird and the like, provide the ability to create hierarchies of folders in which messages may be filed and organized, making it relatively easy to locate and retrieve them at a later date. Despite this inherent capability of such email programs, many users thereof do not avail themselves of this capability because they find the mechanism provided for filing messages is both cumbersome and time-consuming. This in turn may cause such users to suffer from “email overload”, that is, the email Inbox of such a user may become clogged with messages, filling up faster than it can be emptied.

Although many standard email programs provide the capability for filing outgoing messages, many users do not utilize this capability to pre-determine where outgoing messages should be filed after being successfully sent, thereby enabling them to be found again efficiently. Instead, such emails are typically automatically filed in a catch-all “Sent Items” folder, henceforth Sent folder, where they accumulate indefinitely, since few users bother to move and re-file messages in appropriate folders after they have accumulated in the Sent folder.

Sometimes, emails are automatically filed into folders by pre-determined message-handling rules. Indeed, filing all sent emails by default, into a centralized “Sent” folder, is really only a specific example of such a message handling rule.

In general, email programs provide at least one, and generally all three of the following mechanisms for filing a given message into a desired folder: (a) “Drag and drop”, (b) “Most Recently Used (MRU) folders” menu and (c) “Move to folder” dialog
Drag and drop—With this mechanism the user interface displays a hierarchical, or “tree” representation of the folders, indicating the currently selected folder, and generally providing a list of messages in the currently selected folder. Using the mouse, the user selects a message and drags it over the folder tree, dropping it into the desired folder. This mechanism is rather useful when the folders are organized in a relatively flat structure, analogous to alphabetically arranged records, or where there are only a small number of folders. However, where a systematic, hierarchical folder structure is used, giving rise to a deep hierarchy, or when there is a large number of folders, this mechanism requires the user to cause the folder tree to scroll multiple times until the desired folder is displayed, while simultaneously maintaining the drag operation status of the mouse, tracking ball or other cursor navigation tool—henceforth “mouse”. Furthermore, a deep hierarchy requires the user to open multiple nodes of the tree until the desired folder is displayed, while simultaneously maintaining the drag operation status of the mouse. These operations are time consuming; require undisrupted concentration, and also agility with the mouse that is beyond many users.
Most Recently Used (MRU) folders menu—Each time the user files a message in a folder, the identity of that most recently used folder is added to the top of a list of most recently used folders. The number of folders in this list is limited to a small number, typically not more than ten, and the list is displayed on a menu in the email program. When the user wishes to file a message, the user may select a folder from this menu as a quick shortcut. Indeed, if the desired folder appears on the menu, it is an efficient method, but for busy professionals and others who may be have to deal with tens or even hundreds of messages every day, concerning, perhaps dozens of different projects or topics, the MRU list will, all too frequently, not contain the desired folder. Moreover, deep hierarchies often contain a plurality of folders having identical names, but which are located at different places within the hierarchy. For example, a hierarchy for organizing messages pertaining to various departments in a company may contain a “Projects” Solder subordinate to “Finance” and another, distinct “Projects” folder subordinate to “Marketing”. Such a “Projects” folder would be represented on the MRU menu in existing email programs in an ambiguous manner by displaying the folder name only, such that it may be ambiguous as to which of the two “Project” folders the MRU menu entry relates.
“Move to folder” dialog—In order to select the desired folder, the user opens a dialog, which displays a tree representation of the folder hierarchy. Each node on the tree represents a folder. Main folders (or directories) that contain nested subfolders appear with an indicator such as a plus sign icon. The user typically uses a mouse to navigate through the hierarchy by expanding each folder, down the tree, to which the desired folder is subordinate, starting from the top end of the hierarchy. When the desired folder is shown, the user selects it and indicates that this is the desired folder, typically by clicking an “OK” button. In some email programs, regardless of which level of the tree one is, if the user uses inputs a character via the keyboard, the tree display scrolls to display and highlight the first already-visible folder whose name begins with the said character. Though having many advantages, this mechanism requires the user to remember where each desired folder is located in the hierarchy, or to waste time in locating it by trial and error. If there are many folders in a deep hierarchy, it can be rather time consuming to locate and select a deeply nested folder using this method.

U.S. Pat. No. 6,732,155 to Meek, assigned to the Microsoft Corporation, entitled “Dynamic Controlling of Attribute-Specific List For Improved Object Organization” relates to improving object organization by presenting controlling attribute-specific lists. For example, the object may be an email and the controlling attribute may be the sender of that email. Sender-specific lists are dynamically maintained and can include the most recent folders into which emails have been moved. When a current email is selected, or when the user otherwise so indicates, a sender-specific list for the sender of the current email is displayed to the user. The user can select one of the folders from the list as a destination into which the current email is to be deposited. Besides email, the object can be a file, such that the controlling attribute can be the creator of the file.

Essentially, Meek's concept relates to building and using a menu that displays recently used folders per sender or other property of the email messages, so that a user can easily move a received message into a correct folder. The system described in U.S. Pat. No. 6,732,155 to Meek addresses the issue of intuitively filing emails, albeit in a limited way. Specifically Meek has a MRU menu that is constructed for a specific sender and applied to messages from that sender. Although such a filing system may be appropriate in a number of scenarios, it will be appreciated that this arrangement may be inappropriate where a user interacts with a specific contact on a wide range of topics, customers, cases or projects, each of which should preferably be filed separately to be easily found again. A short menu would not suffice for this case.

U.S. Pat. Nos. 5,613,108 and 5,765,170 to Takashi describe an electronic mail processing system and electronic mail processing method. Specifically, an electronic mail system is described in which a mail management method is improved in order to reduce the complexity and labor of handling transmitted information so that its convenience is increased. In an electronic mail system in which a plurality of data processing systems exchange messages through mailboxes utilizing the stored and forward system, the data processing system which receives a mail transferred from the mailbox is provided with an electronic mail terminal utility. When the data processing system receives the mail, the electronic mail terminal utility classifies a data file written in the mail according to specific data contained in the mail and stores the data file in an appropriate folder based on a result of the classification. Thus Takashi's system is essentially about automatically determining the most suitable folder into which to move files that are attached to received email messages. It does not relate to filing emails themselves.

U.S. Pat. No. 5,758,353 and U.S. Pat. No. 5,930,805, both to Marquis describe a computer storage system and processing method for indexing and accessing data stored in the computer storage system, comprising a compact multi-way search tree structure. The method employs a B-tree like search algorithm that is independent of key type or key length because all keys in index blocks are encoded by a log₂ M bit surrogate, where M is the maximal key length. A buffer consisting of a sorted list of key values can be directly transformed into a representation of a C0-tree. Essentially, what is described is a computer system with dynamic storage structure, having a storage unit and a hierarchical tree storage structure for retrieval of stored data in unit with entries linked to the stored data. It will be noted, that in these publications, tree structures in the memory are used for storing and retrieving information.

U.S. Pat. No. 6,035,326 to Miles and Fox relates to an address mapping method for messaging system. Essentially a system and method for creating lookup trees of mapping specifications for multiprotocol messaging environments is described. Specifically, source data, which is preferably updated infrequently, is compiled into a hierarchical tree which is stored in a file. The file contains internal data structures that can be used simultaneously by multiple processes at different virtual addresses. A lookup code finds the longest match, if any, for a given key, in a very efficient manner. In a preferred embodiment, the present invention efficiently maps names between X.400 and SMTP per the RFC1327 specification. The organization of the keys, along with the present invention's partial match characteristics, may also be used to efficiently retrieve domain specific configuration data for an SMTP Message Transfer Agent.

U.S. Pat. No. 6,088,696 to Moon et al., describes a mailing and filing system for congruently categorizing different types of electronic mail resources received tough a messaging system that is essentially a mailing system that includes a file module which directly stores email received as data files of a preselected format. A user operating system is provided for use in a user communications device having a processor controlling a display and a user input device. The processor operates plural application programs, each using data files formatted to the particular application program. A communications terminal is provided, for sending and receiving a plurality of different types of electronic mail including such formatted data files. The user operating system includes a messaging application operating in the processor for congruently categorizing electronic mail received at the user communications device based upon the type of electronic mail received. A mail module is operated by the processor to send and receive electronic mail via the communications terminal. A file module, operably associated with the mail module, defines plural directories for storing data files. The data files in any such directory are of a preselect format, and electronic mail received by the mail module is directly stored as data files in select ones of the directories based upon the type of electronic mail received.

Despite the available methods, the time consuming and cumbersome nature of traditional message filing methods and systems cause many email program users not to file or organize their messages at all. In general, this adversely affects organizational efficiency, and is particularly problematic where one user handles messages in a work environment, and due to illness, staff turnover, maternity leave and the like, another user has to navigate through accumulated correspondence. Thus despite existing systems, there is a need for a user friendly, convenient and intuitive email filing system and the present invention addresses this need.

### SUMMARY OF THE INVENTION

In a first aspect, the present invention is directed to providing a filing assistant for coupling to an e-mail application; the email application comprising a message database for storing and retrieving messages and a graphical user interface for displaying the messages and for allowing the user to otherwise interact with the application; the filing assistant comprising a display and an indexer for generating an optimized folder index.

Typically, the message database is organized into logical folders.

Typically the email application is connectable to a network via a data link, through which the email application sends and receives email messages.

Optionally the filing assistant is coupled to the email application such that the components of the filing assistant have access to the message database of the email application to facilitate retrieval and storage of information and messages.

Preferably the indexer builds and holds a data structure that is optimized for quick discovery of all folders having names containing a given character sequence.

Preferably the indexer has a dedicated display for overriding the GUI of the email application.

Optionally the dedicated display of the filing assistant presents the user with an alternative method of locating folders to that of the GUI integral to the email application.

In a second aspect, the present invention is directed to providing a filing method using the filing assistant comprising a display and an indexer for generating an optimized folder index as described hereinabove, the method comprising the steps of: (a) invoking filing process by a user command; (b) offering a default folder, and (c) displaying a folder tree characterized by forwards and backwards truncation, to show location of select folders with respect to antecedents and dependencies, and (d) accepting a filing option for filing the email.

Typically the user command of step (a) is optionally selectable from the list of SAVE, SEND, CLOSE and the like.

Typically, where the invocation is by an outgoing message being sent, the default filing option offered to user is a Sent folder.

Preferably, the default is overridable by the user being able to select a different option from a displayed list of options.

The other options optionally and typically comprise previously selected folders.

Where invocation is related to an incoming message, the filing assistant optionally queries the existence of an extant previously selected folder.

Typically, generation of an affirmative response results in the email being provisionally filed in the previously selected folder by default. However, in absence of an extant previously selected folder, generation of a negative response typically results in the email being filed into the folder in which current items reside by default.

Preferably the default and other filing options are displayed to the user in context, by generating a filing tree.

In a third aspect, the invention is directed to providing one method of generating a filing tree for displaying the default folder and its hierarchical antecedents, peers and dependencies, comprising the steps of: (i) displaying a folder display dialog with default filing options; (ii) waiting for a user input indicating where the email is to be filed, and (iii) allowing the default filing options offered to be overridden by the user selecting an alternative folder and actively filing emails therein.

Optionally, selection of the folder is by one of the steps selected from the list of: (A) Entering an appropriate alphanumeric string, such as via the keyboard; (B) Selecting a desired folder via a cursor; (C) Accepting an alternative offered by the filing assistant, and (D) Cancelling the filing operation completely.

Where selection of a folder is by entering an alphanumeric string such as via the keyboard, the desired alternative folder is selectable by a text processing means wherein in addition to inputting the case-sensitive correctly typed folder name, a further range of inputted alphanumeric strings open up the correct folder.

In preferred embodiments, inputting a sequence of alphanumeric strings includes, inter alia, inputting first few letters of a desired folder name in a case insensitive manner via the keyboard.

In preferred embodiments, inputting a further range of alphanumeric strings includes, inter alia, inputting a close spelling in a case insensitive manner via the keyboard.

Typically, if only one folder matches the inputted alphanumeric string, a default folder variable is set to the matching folder and a tree is generated and all matches are displayed on the display.

Typically, if more than one folder matches the inputted alphanumeric string, a tree is generated and displayed on the display; the tree showing the default folder in context of sibling, antecedent and dependency folders.

In a fourth aspect, the invention is directed to a method for constructing a tree for displaying multiple matching folders on the display of the filing assistant as described hereinabove, comprising the steps of: Listing folders whose name contains a selected character sequence; Querying uniqueness of a specific folder name; Such that if the folder name is unique, displaying the folder with names of all antecedent folders, back to root folder whereas if folder name is not unique, determining the folder to be a root folder and displaying the folder name without an antecedency path thereto.

In a fifth aspect of the invention, a method for indexing data files in a database is provided. The indexing has a hierarchical arrangement, and the method comprises the steps of: (i) displaying a suggestion; (ii) offering a user the choice of accepting the suggestion or selecting an alternative location by inputting a string of alphanumeric keystrokes, such that when a unique location is specified, the record is filed in that location and the dialog box is closed; however, where the alphanumeric string of keystrokes does not point to a unique location, all locations matching the alphanumeric string of keystrokes are displayed with their full antecedent pathways.

Typically the hierarchical arrangement is a filing system and the records are files, such as emails, for example.

By “tree”, as used herein, a visual representation of a folder hierarchy is intended.

The hierarchical structure of main folders or directories, folders and subfolders are hereunder referred to as the root folder, first generation subsidiary folder, second generation subsidiary folder and so on, where reference is made to a main folder. Alternatively to refer to a particular or selected folder in context, the folder immediately containing the selected folder will be referred to as a parent folder, with all higher level folders to the selected folder being referred to as antecedent folders. Similarly all folders within the selected folder will be referred to as dependency folders, and other folders that are first dependency folders within the parent folder will be referred to hereinafter as sibling folders. More generally, same level folders will be known hereinafter as peer folders.

The term email and message are used interchangeably unless it is clear from the context that only the chosen term is intended.

### BRIEF DESCRIPTION OF THE SEVERAL VIEWS OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

In keeping with standard practice in computer related publications, functional block diagrams and flowcharts are used to describe the structure and methodology of exemplary embodiments of the present invention.

In the accompanying drawings:

FIG. 1 is a functional block diagram illustrating a filing assistant of the present invention, coupled to a standard email application;

FIG. 2 is a flowchart showing the invocation and flow of the filing process in accordance with one way of using the filing assistant of the present invention;

FIG. 3 is a flowchart showing the construction of a tree to display a selected folder in context;

FIG. 4 is a flowchart showing how text entered by a user may be processed by one embodiment of the present invention;

FIG. 5 is a flowchart showing the construction of a tree to display multiple matching folders;

FIG. 6a is an exemplary multiple folder tree display;

FIG. 6b is a second exemplary folder tree display, showing a single folder having a character sequence matching a user input string;

FIG. 7 is a flowchart showing how a message may be filed;

FIG. 8 shows a menu relevant to an incoming message, and

FIG. 9 shows a menu relevant to an outgoing message, while it is being composed.

### DETAILED DESCRIPTION OF THE PREFERRED EMBODIMENT

The present invention relates to improving the process of organizing items in a hierarchical structure, and the process of navigating through the hierarchy. From one angle, the invention is essentially directed to providing a method for displaying a hierarchical folder structure in an intuitive way, which facilitates streamlined and swift interaction between the user and the software, saving considerable time when selecting folders.

By way of example, the invention is described hereinbelow, with respect to filing email messages, within a hierarchical structure of folders in the message database of an email application.

When the user wishes to file a received message, to predetermine the final location of an outgoing message, or to navigate to a folder, the user invokes an improved dialog that facilitates the selection of a folder. Using the keyboard, the user types a sequence of characters that appear in the name of the desired folder. With each keystroke, a list of matching folders is displayed. Each folder in the list appears as the root node of a tree structure, which, where available, can be opened to reveal nested subfolders. If two or more of the matching folders have identical names, they are distinguished by displaying their unique paths. If there is only one matching folder, the full tree is automatically opened up and displayed at a level where the matching folder is pre-selected and shown.

In one embodiment, the user can use the UP and DOWN cursor keys to navigate between the displayed folders to select a desired folder for filing a message within. Typically, the folders can be expanded and collapsed using the right and left cursor keys respectively. Preferably, the user does not even have to use the mouse or keyboard to move the focus to the tree. Rather the tree reacts to the above keystrokes irrespective of where the focus is.

It is noted that transition between keyboard and mouse can be time-consuming, frustrating and cumbersome. Preferred embodiments of the present invention overcome the need for such transitions since the entire operation may be achieved via the keyboard. Specifically, in prepared embodiments, the whole process may be performed in its entirety, from the moment that the first character in the sequence is typed until the desired folder is selected, without the user being required to use a mouse.

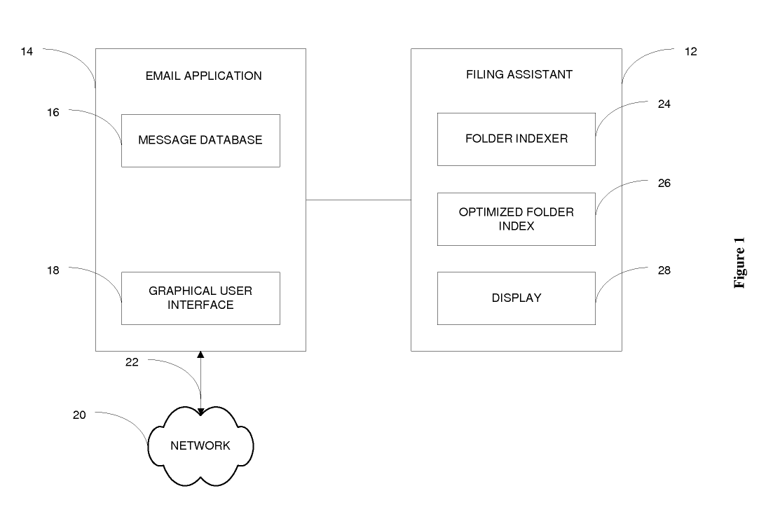

With reference to FIG. 1, a functional block diagram illustrating a filing assistant 12 of the present invention, coupled to a standard email application 14 are shown. Filing assistant 12 operates in conjunction with an email application 14, and may be a standalone application or may be retrofitted thereto, or hosted by the email application 14 as a plug-in.

The email application 14 contains a message database 16 for storing and retrieving messages that are organized into logical folders, and a graphical user interface (GUI) 18 for displaying the messages and for allowing the user to otherwise interact with the application. The email application 14 is typically connectable to a network 20 via a data link 22, through which it sends and receives email messages.

The filing assistant 12 consists of an indexer 24 that generates an optimized folder index 26 and a display 28.

The filing assistant 12 is coupled to the email application 14 such that the components of the filing assistant 12 have access to the message database 16 of the email application 14 and are able to retrieve and store information and messages. Additionally, the components of the filing assistant 12 may interact with the email graphical user interface (GUI) 18 of email application 14, and, where necessary, may override its behavior by using its own display 28.

The filing assistant 12 includes an indexer 24 that generates an optimized folder index 26, which is essentially a data structure optimized for quick discovery of all the folders whose names contain a given character sequence.

The display 28 uses the optimized folder index 26 and presents the user with an alternative method of locating folders to that integral to the graphical user interface 18 of the email application 14.

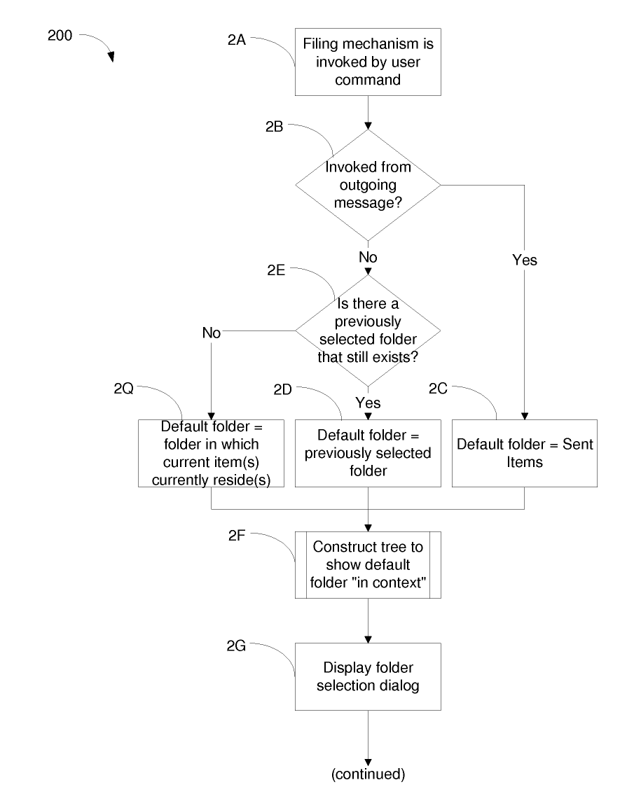

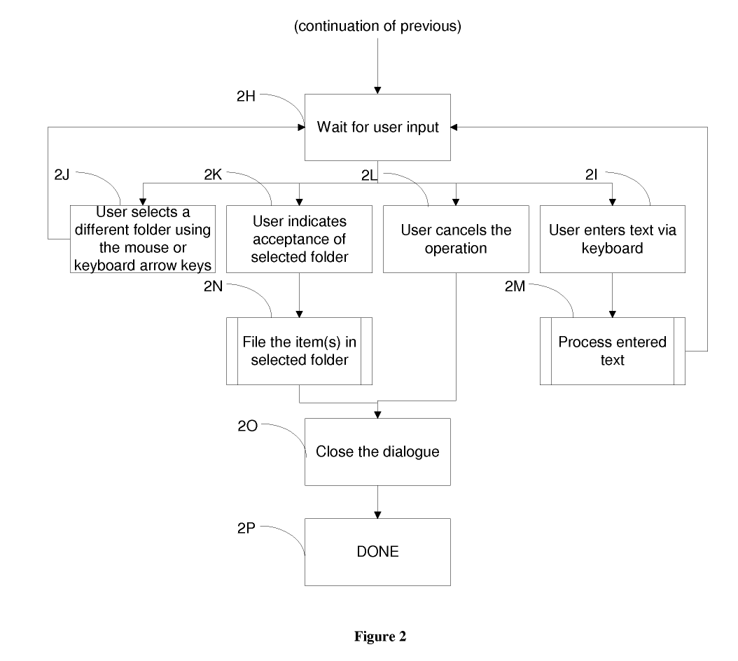

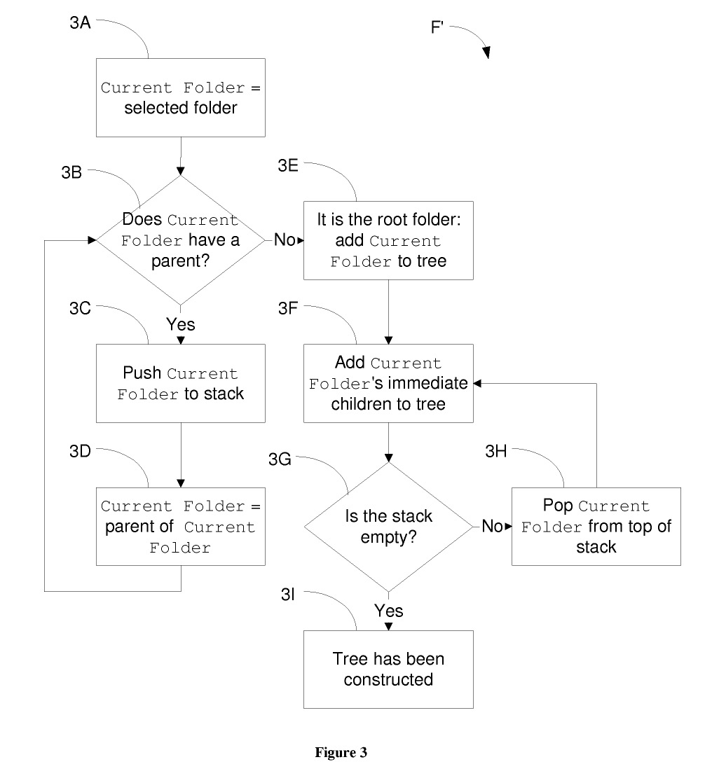

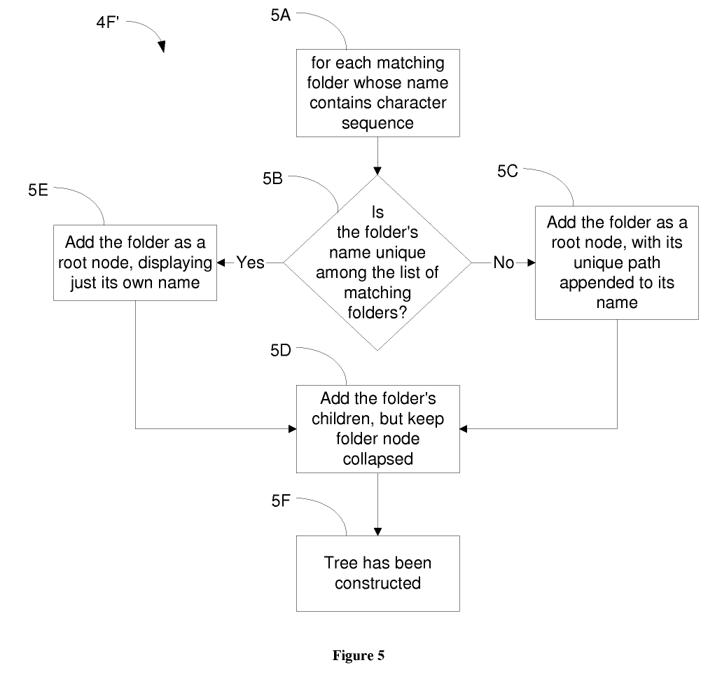

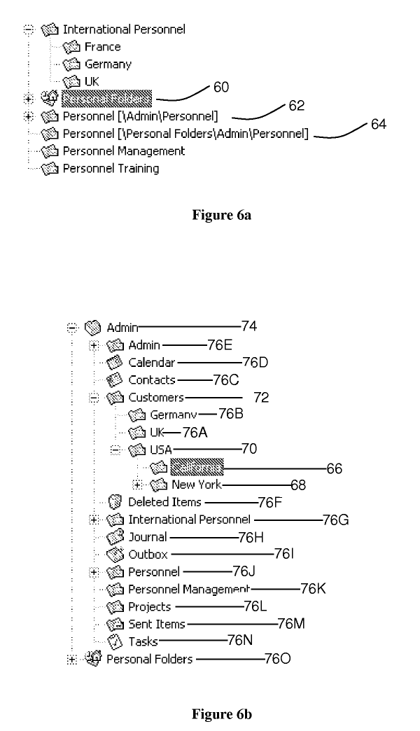

With reference to FIG. 2, one filing method 200 for invoking the filing process, using the filing assistant 12 (FIG. 1) of the present invention are shown. Essentially, the filing method 200 is invoked by a user command 2A such as SAVE, SEND, CLOSE and the like. If the invocation is by an outgoing message being sent 2B, then the default filing option offered to the user will be the Sent Items folder 2C. If the invocation is not by an outgoing message being sent 2B, but rather by an incoming message, then the filing assistant 12 (FIG. 1) would typically query as to the existence of an extant previously selected folder 2E, to which, if an affirmative response is generated, would result in the email being filed in the previously selected folder 2D by default. If, however, there is no extant previously selected folder, the email would be filed, by default, into the folder in which current items reside 2Q. All three alternative defaults filing options 2C, 2D, 2Q are displayed to the user in context, by generating a filing “tree” 2F, one method of generation of which is expanded upon hereinbelow with reference to FIG. 3 that is a flowchart illustrating one method of generating a filing tree 2F′, thereby displaying the default folder and its hierarchical antecedents and peers (and dependencies). A folder display dialog is then displayed 2G and the system waits 2H for a user input indicating where the email is to be filed, allowing the default filing options 2C (and/or 2D, 2Q) offered, to be overridden by the user, allowing user to actively file emails elsewhere, perhaps in an alphabetically arranged customer system or by topic, for example. The user is able to select an alternative folder by entering 2I an appropriate alphanumeric string, such as the desired folder name via the keyboard. The user may alternatively select the desired folder via the cursor 2J, either by using the cursor control keys (typically the UP and DOWN arrows), or via a mouse, tracker ball or the like. The user can, however, simply accept the alternative offered 2K or may cancel 2L the filing operation completely. In preferred embodiments, where the user provides an input 2H by entering 2I an alphanumeric string, the desired alternative folder is selectable by a text processing means 2M allowing selection by a range of alphanumeric strings and not simply the exact, case-sensitive, correct folder name. By way of non-limiting example, the filing assistant 12 (FIG. 1) may be configured such that inputting the first few letters of the desired folder name via the keyboard will be sufficient. Preferably a close spelling is sufficient and the system is not case sensitive. By way of enabling example only, one specific method in which entered alphanumerical data (text) is processed by one embodiment is described in more detail hereinbelow, with reference to FIG. 4, and one specific method in which an email may be filed within a folder accepted by the user 2K is expanded upon, hereinbelow, with reference to FIG. 6.

Essentially, whether the user provides input 2H by entering 21 an alphanumeric string, or whether the user selects the desired folder via the cursor 2J, the user will be referred back to providing input 2H unless the selected folder offered is the desired one in which case user will accept 2K the selected folder and file the email 2N therein, or simply cancel 2L the operation. The dialog is then closed 2O, and the routine is terminated 2P.

With reference now to FIG. 3, one methodology (or algorithm) of constructing a tree 2F′ to display the selected folder in context is now described. First, a variable, labeled for convenience as Current Folder is set 3A to the selected folder inherited from one of previous steps 2C, 2D, 2E. Second, the existence of a parent folder is queried 3B. If there is a parent folder, the Current Folder is pushed to stack 3C. A reiterative loop is now entered, and the value of the Current Folder variable is set 3D to the value or identity of the parent folder 3B, and the existence of a parent folder is (again) queried 3B, until there is no parent folder to the Current Folder, i.e., the Current Folder is a root folder, and the Current Folder (root folder) is added 3E to the tree. Next, the dependencies of the Current Folder (root folder) are added 3F to the tree. The emptiness of the stack is now queried 3G, and, if the response is negative, then the Current Folder is popped 3H from the top of the stack and the dependencies of the Current Folder are again added 3F to the tree. The loop of steps 3F, 3G, 3H is repeated until the query regarding the emptiness of the stack 3G gives a positive response. Then, since the construction of the tree is finished, the folder selection dialog 2G (FIG. 2) may be displayed.

FIG. 4 is a flowchart showing one implementation 2M′ of the processing step 2M of FIG. 2. Thus, one specific method 2M′ for processing the text entered by a user in step 21 (FIG. 2) might be to retrieve a list of folders whose names contain the character sequence from an optimized folder index 4A. The number of folders containing the character sequence is queried 4B. If the response is zero, then a message indicating no matching folders is displayed 4C. If exactly one folder contains the character sequence, the default folder variable is set to the matching folder 4D and a tree is constructed 4E that shows the default folder in context, perhaps by implementing the method 2F′ described hereinabove with reference to FIG. 3. If, however, more than one folder contains the character sequence, a tree is constructed 4F that shows the matching folders.

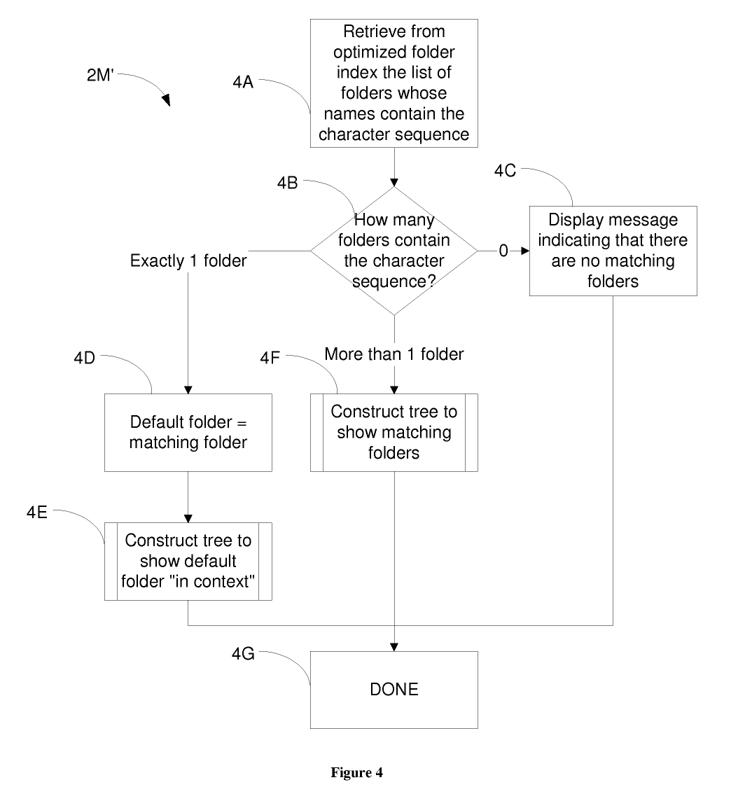

Referring now to FIG. 5, one specific method 4F′ for constructing a tree to display multiple matching folders is shown. The output display of the method is described hereinbelow with reference to FIGS. 6a and 6b. A list of folders whose name contains a selected character sequence is constructed 5A. The uniqueness of a specific folder name is queried 5B, and if the query generates a negative result, the folder is displayed with its path 5C, i.e. the name of the antecedent folders, back to the root folder, or the concatenation thereof. The dependency folders are displayed 5D keeping the specific folder collapsed. If, when the uniqueness of a specific folder name is queried 5B, the query generates a negative response, the folder is displayed as a root of a tree and it is displayed in its own name 5E with an antecedency path. Once again, however, the folder dependencies are added 5D, dependency folders are displayed keeping the specific folder collapsed, and the tree is considered as constructed 5F (DONE).

With reference to FIG. 6a, an exemplary multiple folder tree display as generated by FIG. 5 is shown, in which the tree displays multiple folders that match a character sequence typed by user, in this case the term “per”. It will be noted that each matching folder forms the root of a tree that can be expanded to show all nested folders subordinate to the matching folder. The currently selected folder 60 is displayed highlighted in the traditional way. Folders 62, 64 having identical names are distinguished by showing their full paths.

FIG. 6b is a second exemplary folder tree display, showing a single folder having a character sequence matching a user input string. Specifically, for a character sequence typed by the user of “calif”; since only a single match for the character sequence “calif” is found: the “California” folder 66. The matching folder 66 is displayed at its location in the tree, with all its siblings 68 and antecedents 70, 72, 74 and their siblings 76A-76O all the way back to the root folder. Specifically, the “California” folder 66 is shown nested under USA 70, which in turn is nested under Customers 72 under the Admin 74 root folder.

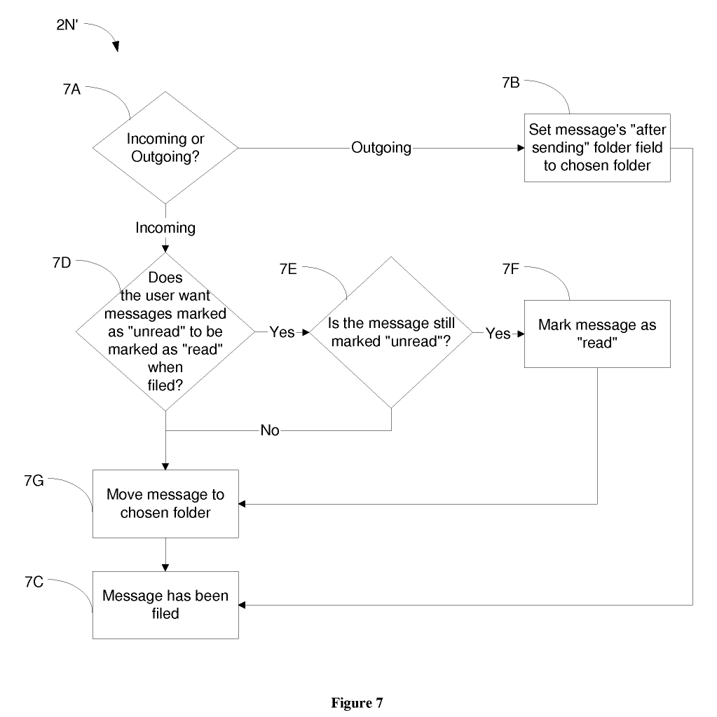

Referring now to FIG. 7, one specific method 2N′ in which an email may be filed 2N within a folder accepted 2K by the user (See FIG. 2) is now detailed. Essentially, the nature of the email is queried 7A. If the email is an outgoing email, the email “after sending” field is set to the selected folder 7B, and the message is considered as filed 7C, although, strictly speaking, it will only actually be moved to the selected folder once it has been successfully sent. If, however, the message is not an outgoing email message, it is an incoming message and usefully, a subroutine is executed that marks the message as having been read when it is filed away. Thus, the user is able to choose 7D to execute the subroutine, and if such a choice is made, such emails that are marked as unread 7E are marked as having been read 7F prior to moving to the chosen folder 7G for filing 7C. If the user chooses 7D not to reclassify unread messages as having been read, he may simply move the message to the chosen folder 7G for filing 7C.

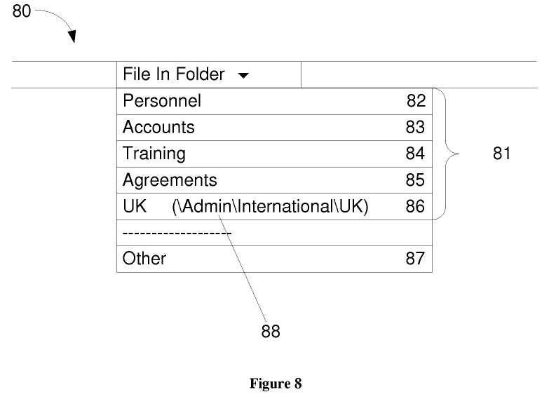

FIG. 8 shows a typical menu 80 relevant to an incoming message. Typically a list 81 of the most recently used folders 82-86 is displayed, with the number of folders displayed being application specific, or user determinable, perhaps offering the ten most recent selections, for example. It will be noted that the full path 88 of the “UK” folder 86 is shown, because, with reference to FIGS. 6a and 6b, there exist more than one folder named UK in the message database folder structure. Selection of OTHER 87 might open up a dialogue, for example, allowing the user to select a folder not on the above like.

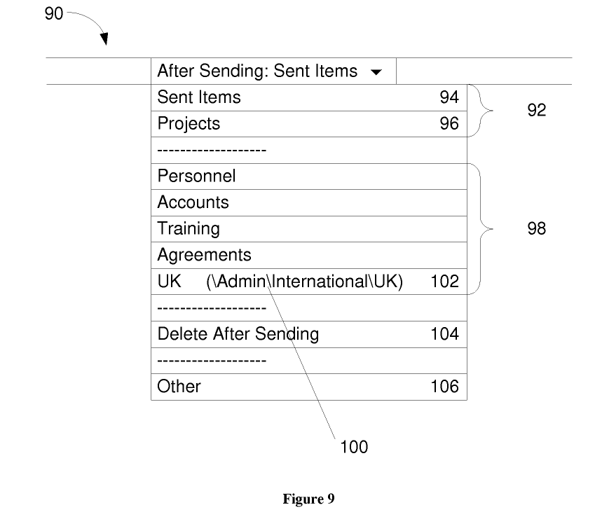

With reference to FIG. 9, a typical menu 90 relevant to an outgoing message is shown. Typically, such a menu 90 would be shown, while the message is being composed. A list 92 of folders 94, 96 where the item would likely be filed is shown. A sub list 98 of the most recently used folders is also shown. Note, the full path 100 of the “UK” folder 102 is shown, because there exist more than one folder 86 (FIG. 8), 102 (FIG. 9) with that name in the message database folder structure.

Selection of DELETE AFTER SENDING 104 causes the message not to be saved after being sent. Selection of OTHER 106 might open up a dialogue, allowing the user to select a folder not on list 90.

It is especially noted, that unlike standard methods for navigating email filing systems such as those used in current versions of Microsoft Office Outlook, Outlook Express, Thunderbird, Eudora, Lotus Notes, and the like. Preferred embodiments of the invention combine display methods with keyboard interaction, and avoid using a mouse. Since the user is not required to attempt to locate a folder whose location is forgotten, a considerable amount of time is saved, and this improves both the user's ability and the user's inclination to keep messages organized.

A major feature of the invention is that folders matching an alphanumeric search string input by user in 21 (FIG. 2) are displayed with their antecedencies collapsed as a path, whereas the dependencies are shown in expanded form. This type of display which provides an optimal view of useful information, both “upstream” and “downstream”, appears to be a novel development of the present invention. It is apparently not encountered in previous hierarchical indexing or tagging systems in general, and email filing systems of the prior art in particular.

Although described hereinabove with reference to a preferred embodiment for filing email messages within a hierarchical structure of folders in the message database of an email application, it will be appreciated that the present invention is not limited to what has been particularly shown and described hereinabove. The process of organizing items in a hierarchical structure, and the process of navigating through the hierarchy has wider application. Thus the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

I claim:

1. A filing assistant for coupling to an e-mail application;
The email application comprising a message database for storing and retrieving messages and a graphical user interface (GUI) for displaying the messages and for allowing the user to otherwise interact with the application;
said filing assistant comprising a display and an indexer for generating an optimized folder index.

2. The filing assistant of claim 1, said message database being organized into logical folders.

3. The filing assistant of claim 1, said email application being connectable to a network via a data link through which said email application sends and receives email messages.

4. The filing assistant of claim 1 being coupled to the email application such that the components of the filing assistant have access to the message database of the email application to facilitate retrieval and storage of information and messages.

5. The filing assistant of claim 1, said indexer being a data structure optimized for quick discovery of all folders having names containing a given character sequence.

6. The filing assistant of claim 1, having a dedicated display for overriding the GUI of said email application.

7. The filing assistant of claim 6, said dedicated display for presenting the user with an alternative method of locating folders to the GUI integral to the email application.

8. A filing method using the filing assistant of claim 1, comprising the steps of
(a) invoking filing process by a user command;
(b) offering a default folder;
(c) displaying a folder tree characterized by forwards and backwards truncation, thereby showing location of select folders with respect to antecedents and dependencies.

9. The filing method of claim 8, said user command comprising commands selected from the list of SAVE, SEND, CLOSE and the like.

10. The filing method of claim 8, wherein if the invocation is by an outgoing message being sent, the default filing option offered to user is a Sent folder.

11. The filing method of claim 8, said invocation being by an incoming message, the filing assistant querying the existence of an extant previously selected folder.

12. The filing method of claim 11, wherein generation of an affirmative response results in the email being filed in the previously selected folder by default.

13. The filing method of claim 8 wherein in absence of an extant previously 10 selected folder, generating a negative response results in the email being filed into the folder in which current items reside by default.

14. The filing method of claim 8 wherein default filing options are displayed to the user in context by generating a filing tree.

15. The filing method of claim 8 wherein one method of generating a filing tree for displaying the default folder and its hierarchical antecedents, peers and dependencies comprises the steps of:
(i) displaying a folder display dialog;
(ii) waiting for a user input indicating where the email is to be filed;
(iii) allowing the default filing options offered to be overridden by the user 20 actively filing emails in an alternative folder by selecting an alternative folder.

16. The filing method of claim 15, the selecting of the alternative folder is by one of the steps selected from the list of:
(A) Entering an appropriate alphanumeric string, such as via the keyboard;
(B) Selecting a desired folder via cursor control keys;
(C) Accepting an alternative offered by the filing assistant, and
(D) Cancelling the filing operation completely.

17. The filing method of claim 15, wherein the selecting of the alternative folder is by entering an alphanumeric string such as via the keyboard; the desired alternative folder being selectable by a text processing means wherein in addition to inputting a case-sensitive correct folder name, a further range of inputted alphanumeric strings open up the correct folder.

18. The filing method of claim 17, said inputting a further range of alphanumeric strings includes either:
(a) inputting first few letters of a desired folder name in a case-insensitive manner via the keyboard, or
(b) Inputting a close spelling in a case-insensitive manner via the keyboard.

19. The filing method of claim 17, wherein:
(a) if only one folder matches inputted alphanumeric string, a default folder variable is set to the matching folder and a tree is generated and displayed on display, said tree showing said default folder in context of sibling, antecedent and dependency folders; whereas
(b) If more than one folder matches an inputted alphanumeric string, a tree is generated and displayed on display, said tree showing matching folders as roots, with a default folder highlighted.

20. A method for constructing a tree for displaying multiple matching folders on the display of filing assistant of claim 1, comprising the steps of:
(i) Listing folders whose name contains a selected character sequence;
(ii) Querying uniqueness of a specific folder name;
(iii) If folder name is not unique, displaying the folder with names of all antecedent folders, back to root folder, whereas
(iv) If folder name is unique, determining the folder to be a root folder and displaying its own name without an antecedence path.

21. The method of claim 20 further comprising displaying dependency folders whilst keeping the specific folder collapsed.

22. A method for indexing data files in a database, the indexing having a hierarchical arrangement, said method comprising the steps of:
(i) displaying a suggestion in a dialog box;
(ii) offering user a choice of either accepting the suggestion or selecting an alternative location by inputting a string of alphanumeric keystrokes, such that, when a unique location is specified, filing the record in that location and closing dialog box, however where the alphanumeric string of keystrokes does not point to a unique location, displaying all locations matching the alphanumeric string of keystrokes with full antecedent pathways.

23. The method of claim 22, said hierarchical arrangement being a filing system, said records being files.

24. The method of claim 23, said files being emails.
